(19) United States
(12) Patent Application Publication
(10) Pub. No.: US 2001/0039665 A1
(43) Pub. Date: Nov. 8, 2001

(54) System and method for enhancing a serial transmission

(76) Inventor: David Wilkins, Montreal (CA)

Correspondence Address: WELLS ST JOHN ROBERTS GREGORY AND MATKIN, SUITE 1300, 601 W FIRST AVENUE, SPOKANE, WA, 992013828

(21) Appl. No.: 09/827,730

(22) Filed: Apr. 6, 2001

(30) Foreign Application Priority Data
Apr. 7, 2000 (CA) 2,304,286

(51) Int. Cl. H04N 7/16

(52) U.S. Cl. 725/143

(57) ABSTRACT

A system and method for enhancing a serial transmission, such as for example, a television broadcast by combining selected data with the conventional serial transmission signal is described herein. The type of data is selected via a template that is used to merge and format the data. The data is combined with the serial transmissions to yield an enhanced serial transmission.

### FIELD OF THE INVENTION

The present invention relates to a system and method for enhancing a serial transmission. More specifically, the present invention is related to a system and method for formatting and merging collected data with a television signal to yield an enhanced signal.

### BACKGROUND OF THE INVENTION

The migration of present day television broadcasting more and more towards the use of the digital form as the preferred method of transmission, combined with the digitization of audio transmission and the ever increasing use of the Internet as a preferred form of data transfer, has led to a homogenization of the underlying media used for the transmission of all these sources of data.

The above migration, often referred to as convergence of the transmission media, has not only affected the means by which information is transmitted, but is also having a major impact on the manner in which information is used and the manner in which a viewer interacts with that information. Additionally, the increasing penetration of the combination of the general purpose Personal Computer (PC) and the Internet into North American households, as well as the marked increase in the amount and types of information which may be transmitted by the data networks underlying the Internet, appears to herald the end of the traditional method of TV broadcasting, whereby a viewer passively receives information, with little influence on the information he receives or the manner in which that information is displayed.

One major advantage digital transmission methods have over traditional analogue broadcasting methods is the inherent two-way nature of the information flow. Although broadcasting in its current form, as discussed above, looks set to continue well on into the future, the two-way nature of the transmission media has opened up exciting new avenues of development for the producers of content slated for broadcast.

One aspect which is currently the object of much interest is the use of two-way transmission to enhance a broadcast viewing experience by providing the viewer with the tools to interact with a broadcast and customize the manner in which the transmitted information is displayed. Traditionally live television broadcasts are the result of multiple video and audio feeds and a producer's talent for combining the feeds to create content which provides for maximum visual effect while maintaining viewer attention.

Recent developments in image processing, transmission and computerized support for image capture and editing have provided the producer with an array of tools with which he can further enhance the content of a broadcast. One important aspect is the combination of animated graphics with the video being broadcast, primarily through superimposing the graphics on the broadcast video, as a method for conveying to the viewer additional detailed information on a given aspect of the broadcast without interrupting the transmission thereof.

A number of systems and approaches have been disclosed in the following prior art documents which take advantage of the two-way nature of communications to provide some degree of interactivity between viewer and broadcaster as well as the manner in which information is displayed:

| | |
|---|---|
| US 5,534,913 | Majeti et al. |
| US 5,585,858 | Harper et al. |
| US 5,775,664 | Hidary et al. |
| US 5,861,881 | Freeman et al. |
| US 6,018,768 | Ullman et al. |

U.S. Pat. No.5,534,913 by Majeti et al. discloses an apparatus which uses an existing broadcasting network, such as a cable television distribution network, to transfer data to viewers equipped with personal computers, while simultaneously allowing such viewers to transmit data from their computers to the enhanced data providers via a secondary communication path such as that provided by modem and the public telephone system. The patent describes primarily a system for using a portion of the bandwidth of an existing cable network as the downlink communication path for a generalized packet data communication system. The preferred embodiment, however, does mention the use of the system for a number of enhanced services, e.g. the display of a message indicating that any of a number of predetermined conditions have arisen (the example of when the price of a given stock reaches a viewer defined target value is provided). The message is displayed on a portion of the screen of the TV (⅓^{rd} of the screen is proposed) so as not to interrupt the normal viewing.

U.S. Pat. No.5,585,858 by Harper et al. describes a system for simultaneously broadcasting an interactive TV program with a normal conventional broadcast in the same standard video signal bandwidth. The interactive portion of the programming consists of audio and graphic data, a portion of which may be stored locally on a local storage device such as a CD ROM or solid state game cartridge. The viewer can individualize a particular broadcast by selecting audio and video graphic overlays. This document also discloses the use of “trigger points” spread throughout a broadcast which, when activated, invoke macros which call for certain interactive function, e.g. the overlay of a particular graphics screen or the playing of a personalized audio signal. The exact timing of the trigger points is unknown to the viewer in order to make them appear unsolicited.

U.S. Pat. No.5,774,664 by Hidary et al. discloses a system for integrating video with data available over the Internet. In the preferred embodiment, this is done by coding a Uniform Resource Locator, or URL, in the Vertical Blanking Interval (VBI) of the video signal. A personal computer equipped with an appropriate TV video card and web browser extracts the URL from the VBI and, at appropriate times, directs the web browser to retrieve and display the identified web page from the Internet. The web page is foreseen for display in a portion of the screen within which the video is not displayed. Alternatively, the URL is not coded into the VBI but rather is available via a website. In this embodiment, broadcasters schedule real live time transmissions of URLs to viewers at the same time as the broadcast. This embodiment would also allow individual viewers to customize the URL transmissions based on a viewer profile.

U.S. Pat. No. 5,861,881 by Freeman et al. discloses an interactive computer system. The system is based upon “branches” which occur during the course of a full-motion video. The branches may be to another video segment, or to graphic and audio segments which are integrated into the video. The preferred embodiment uses a combination of branches which are the result of viewer input or in response to a trigger point interspersed by the broadcaster within the video segment. The system can branch between video from a number of sources, e.g. live video broadcasts, video stored on disk and graphic and audio data stored on disk.

U.S. Pat. No.6,018,768 by Ullman et al. describes another system for integrating video programming with information available on the Internet. URLs, as described above, are imbedded in video transmissions and these URLs are used to retrieve web pages related to the transmission.

Although the above related sources of prior art allow the viewer to receive individualized content and in some manner modify the way in which that content is displayed, none of these documents discloses a system which allows the viewer to combine a broadcast with graphical elements capable of being modified in real-time from any of a number of data sources. Additionally, the prior art does not reveal a system where the manner in which data displayed on a video screen can be defined by the viewer using a template and graphical elements which are positioned within the template.

### SUMMARY OF THE INVENTION

The present invention addresses the above limitations by providing a system that allows broadcasters to simultaneously deploy interactive content for live television, broadband Internet, streaming video, interactive TV, and wireless devices.

More specifically, according to a first aspect of the present invention, there is provided a system for a viewer's customization of the presentation a serial transmission and data on a display comprising:

means for positioning and displaying the serial transmission on the display;

at least one data collector supplying the data;

at least one viewer selectable graphics object having an appearance, wherein each of said at least one graphics object is connected to a corresponding one of said at least one data collector and wherein each graphics object appearance is modified according to the data of said corresponding one of said at least one data collector; and

means for positioning and presenting said at least one graphics object on the display.

According to a second aspect of the present invention, there is provided a method for a viewer's customization of the presentation of a serial transmission and data on a display comprising:

positioning and displaying the serial transmission on the display;

providing at least one graphics object having respective appearances;

selecting at least one graphics object having an appearance;

positioning said at least one graphics object on the display;

providing at least one data collector having data;

connecting said selected at least one graphics object to a corresponding one of said at least one data collector;

transferring the data from said corresponding data collector to said at least one graphics object; wherein each graphics object appearance is modified according to the data of said corresponding data collector; and

displaying said at least one graphic object on the display.

According to a third aspect of the present invention, there is provided a interactive system for modifying graphics displayed with a serial transmission comprising:

means for requesting viewer input;

means for receiving and processing said viewer input and having an output;

at least one graphics object having an appearance;

means for modifying said appearance of said at least one graphics object connected to said receiving and processing means, wherein said at least one graphics object appearance is modified according to said output;

means for combining said at least one graphics object with the serial transmission to form an enhanced serial transmission.

According to a final aspect of the present invention, there is provided a method for enhancing a serial transmission and displaying this enhanced transmission on a display comprising the steps of:

in a pre-production phase:

creating a template including at least one graphics object;

making the template available;

in a post production phase:

providing a serial transmission;

providing at least one data collector having data;

acquiring said template;

linking said at least one graphics object of the template to a corresponding data collector;

modifying said at least one graphics object according to the real time modified data of the data collector; and

displaying the combination of said serial transmission and said at least one graphics object on the display.

### BRIEF DESCRIPTION OF THE DRAWINGS

In the appended drawings:

FIG. 1 is a schematic diagram of the system in accordance with a preferred embodiment of the present invention;

FIG. 2 is a schematic diagram of the template authoring station in accordance with a preferred embodiment of the present invention; and

FIG. 3 is a schematic flow chart of the method according to an embodiment of the present invention.

### DETAILED DESCRIPTION OF THE PREFERRED EMBODIMENT

Generally stated, the system of the present invention allows for the combination of television broadcasting with two-way communication capabilities, for example, through of the Internet, to create a customizable and interactive television viewing experience.

Indeed, the present invention discloses a system for enhancing a serial transmission with data. The serial transmission is typically of a type that provides moving video images when projected on an appropriate display device. The data is typically of a type, as will be seen below, which is complementary to the images being displayed but there is essentially no limit to the kinds of data that can be displayed.

Once combined with the moving images of the serial transmission, the data will have been converted into a graphical format. A template is used to determine the position of the data converted into its graphical form on the display device. The template, which has previously been loaded in the display device, provides information to a given display device as to the graphical forms into which the data is to be converted and as to the positioning of the data on the display device.

In a final step, the system combines the data with the serial transmission (for example, in the form of moving images) to form an enhanced serial transmission in the form of an enhanced signal.

Additionally, the system according to the present invention allows for an interactive component to be introduced into a serial transmission by providing the means for displaying audience responses to interactive questions.

In the preferred embodiment, the serial transmission disclosed is an analogue NTSC TV broadcast, although it should be understood to include any number of transmission types, including but not limited to streaming video, MPEG or digital TV.

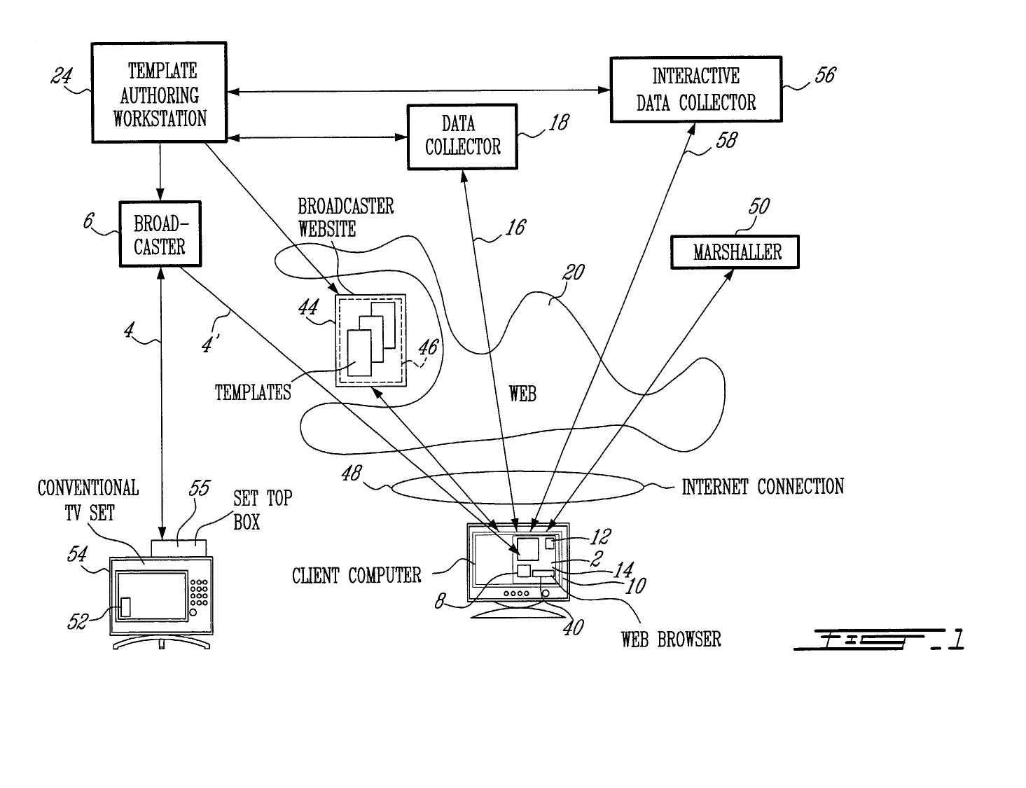

Referring now to FIG. 1 of the appended drawings, a system according to an embodiment of the present invention will be described.

As is widely known, in a conventional system, a broadcaster 6 broadcasts a conventional serial transmission to a conventional TV set 54 which displays it in a known manner.

In the system of the present invention, data is collected and stored by a data collector 18. The data is typically of a type with a moderately short useful life, and includes information from a variety of different sources including online clocks, weather reports, stock and currency exchange reports, sports scores and statistics, for example. The data may also be, for example, information related to political broadcasts such as polls and vote results, candidate biographies, pictures of candidates and related information. Of course, the data may be collected in real time, i.e. in synchronism with the serial transmission, or before this serial transmission.

The preferred embodiment of the system of the present invention uses a templates, provided by the broadcaster, to format collected data 16 from the data collector 18 which is then combined with a TV broadcast 4 or 4′ received from the broadcaster 6. Using graphic objects 8, the template, previously loaded in the client's display describes a layout on a display where and how the data 16 should be displayed on a client's computer 10.

The client's display may be a computer 10 equipped to interpret the template and receive the enhanced transmission signal or a conventional television set 54 provided with an adequate set-top box 55 receiving a signal via airwaves or cable, for example. Again, the set top box 55 is configured to interpret the template and display the enhanced serial transmission adequately.

The graphic objects 8, can be of a number of different types. For example, standard user interface graphic objects such as list boxes, drop lists, animated buttons and text boxes can be used to display information to a viewer or to request viewer input. Additionally, the range of graphic objects 8, including their behavior and visual appearance, can be supplemented by specialized graphic objects (not shown) which can be developed according to the requirements of the producer. This could include, for example, a bar chart, clock, pie-chart, archived video or any other graphic or information which is complementary to the broadcast. Additionally, graphic objects may be developed in ActiveX or Java thereby providing the producer with a virtually unlimited opportunity to develop customized graphic objects to be included in a given broadcast.

A client plug-in application 14 capable of interpreting the template 2 is installed into the web browser 12 allowing the viewer to load a template 2 and use it as a basis for formatting the TV broadcast 4′ and selecting and positioning graphic objects 8 for displaying data 16 on the web browser 12.

The graphic objects 8 receive data 16 from a data collector 18 via the Internet 20, for example. The data collectors 18 are the same as those that would be used by a broadcaster in creating graphical content for a particular broadcast. Of course, more than one data collector 18 could be used should the data be disseminated. Similarly, the connection between the object could be done by another medium than the internet, for example, via airwaves.

According to a preferred embodiment, the use of the system may be divided into a pre-production phase and a post-production phase.

Pre-production Phase

The following provides an illustrative example of the pre-production phase of a system in accordance with the preferred embodiment of the present invention.

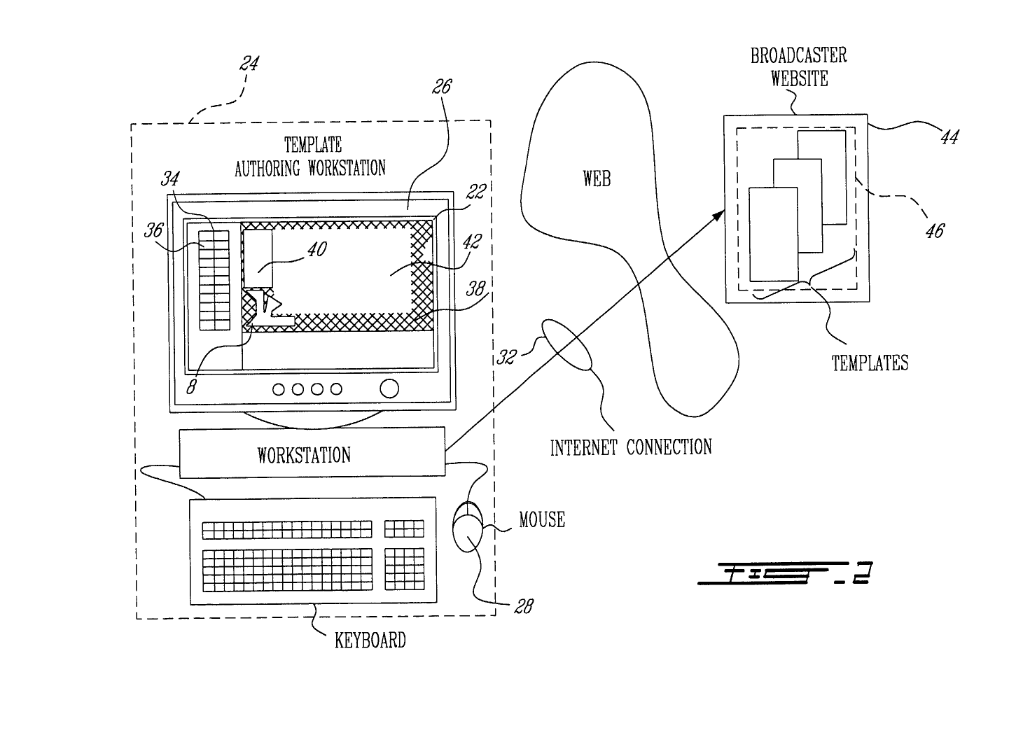

Referring to FIG. 2, in the pre-production phase, a software based template authoring tool 22 is implemented on a general purpose computer workstation 24, the computer including a display 26, a mouse 28, a keyboard 30 and an Internet connection 32.

Using the template authoring tool 22, the producer selects at least one standardized graphic object 8 from a toolbox 34 of available graphic objects 36 using a mouse 28 or keyboard 30 and inserts the selected graphic object 8 into a preferred position on the workspace 38. Note that the available graphic objects 36 include one or more interactive graphic objects 40 that may also be inserted into the workspace 38. The function of these interactive graphic objects will be described hereinbelow. The producer also designates the display region 42 for the serial transmission within which the television broadcast is to be displayed. Of course, the number and type of graphical objects 8 and interactive graphic objects 40 selected and placed on the workspace 38 is at the producer's discretion.

As stated above, the graphic objects 8, can be one of a number of different types.

Once the producer has finished selecting and positioning the graphic objects 8 on the workspace 38 and selected the video display region 42, the workspace 38 may be published to create a template 2.

In the preferred embodiment herein described, publishing is generally to be understood as rendering the template in a format which can be read and understood by an appropriate client plug-in or other pieces of software, installed in a viewer's web browser or set top box, for example. The template 2, would then be placed, for example, on the broadcaster's web site 44 via the Internet connection 32 or supplied to the set top box via the connection (RF or cable) to the broadcaster. The viewer would have access to the portion of the broadcaster's web site 44 allowing the use of the template 2 as the basis for viewing a broadcast provided the viewer's web browser is equipped with the appropriate client plug-in.

Note that although the above makes reference to the use of the broadcaster's website 44 as the preferred method of distribution for the templates 2 to a viewer, it should be understood that any of a number of conventional distribution methods could be used for templates distribution, including CD-ROM and floppy disk.

A producer may publish a group of templates 46 for each broadcast with the viewer able to select the template 2 which corresponds best to the viewer's personal tastes. Alternatively, a sole template 2 may be used that contains objects that are removable or customizable by the viewer, thereby not requiring a user's choice of template. In this case, the user would select which graphics object is to be displayed along with the serial transmission.

Post-production Phase

The following provides an illustrative example of the post-production phase of the system in accordance with the preferred embodiment of the present invention. This example will first describe the operation when the viewer uses a computer 10 and then the operation when the viewer uses a conventional TV set 54.

Using a Computer

In the post-production phase, the group of published templates 46 has been made available to a viewer at an appropriate location, for example the broadcaster's website 44, although any conventional storage means could be used, including CD-ROM and floppy disk.

Referring back to FIG. 1, the viewer's computer 10 is equipped with an Internet connection 48, for example via a high speed line, a RF connection or a conventional modem. A conventionally available web browser is installed on the client computer 10 along with the client application plug-in 14 for reading the template 2.

The viewer selects a single template 2 from the group of templates 46 on the broadcaster's website 44 for a particular broadcast. In the cases where only one template is available, the plug-in may download it automatically without the assistance of the viewer.

If the template 2 is customizable by the user, the user may do so at any time during the post-production phase.

On loading the template in the client computer 10, the client plug-in 14 communicates via the Internet connection 48 with a marshaller 50 and requests information regarding the address of the data collector 18. The marshaller 48 returns the address of the data collector 18 to the client plug-in 14 and also indicates whether the connection to be used will be permanent or on demand. If permanent, the client plug-in 14 opens a connection to the data collector 18 using the TCP connection oriented protocol. If on-demand, the client plug-in 14 connects to the data collector 18 via the TCP connection oriented protocol and provides the data collector 18 with the address of the client plug-in 14. The client plug-in 14 then closes the connection and then sets up a local server to listen for updates from the data collector 18. Of course, other methods could be used to find the address of the data collector 18 or to otherwise link the graphics objects with the data collector.

The client plug-in 14 receives data 16 from the data collector 18 from time to time. The data 16 will modify the appearance of the graphic object 8 depending on the graphic object attributes and behavior. There is no requirement on behalf of the viewer to refresh the screen for modifications to the graphics to take place. Communications between the client plug-in 14 and the data collector 18 as well as updates to the graphic objects 8 are carried out automatically and no interaction on behalf of the viewer is required.

Graphic objects 8 may have one or more viewer definable attributes. Modification of these attributes may modify general characteristics of the graphic object, for example text color or font used, but may also be used to modify the general characteristic of the object, for example the display of data as numbers or as a bar chart, or modify the behavior of the graphic object 8 on receipt of data 16 from the data collector 18. One of these attributes is advantageously the removal of the object from the displayed objects.

During transmission of the television broadcast 4′ interactive actions on behalf of the viewing audience may be requested. The interactive graphic object 40 provides the interface by which a viewer may provide a response to a request for interactive actions, via conventional input devices such as a keyboard, a mouse or a remote control, for example. This response may include, for example, voting on a particular item or selecting one of a number of pre-defined responses displayed by the interactive graphic object 40. When the viewer submits a response, the client plug-in 14 transmits, from the interactive graphic object 40, response data 58 to the interactive data collector 56.

The serial transmission of the enhanced signal 4′, that has been enhanced by the data, may then be “webcasted” by the broadcaster 6 to the computer 10, for example, via the Internet connection 48.

The elements required for such webcast are believed well known to these skilled in the art and will therefore not be further discussed herein.

It is to be noted that should more than one graphic object 8 be used on the template 2 selected by the user, the client plug in 14 would potentially open two links to two different data collectors 18 (only one shown on FIG. 1) should the data required be distributed.

Using a Conventional TV Set

When a conventional TV set 54 provided with a set top box 55 is used to obtain and interpret the template2, this template is advantageously supplied of the set top box 55 via the connection (for example RF or cable) between the box 55 and the broadcaster 6. This template is subsequently used to format the incoming enhanced serial transmission as described hereinabove so that it may adequately be displayed on the TV set 54.

If the template 2 is customizable by the user, the user may do so at any time during the post-production phase, via the use of a remote control, for example.

When using a set top box, the enhanced serial transmission contains the required data supplied by the broadcaster 6 by the data collector 18 and/or the interactive data collector 56.

Again, the data received will modify the appearance of the graphic object 8 depending on the graphic object attributes and behavior.

During transmission of the television broadcast 4 interactive actions on behalf of the viewing audience may be requested. The interactive graphic object 40 provides the interface by which a viewer may provide a response to a request for interactive actions, via conventional input devices such as a remote control, for example. Response data is transmitted to the interactive data collector 56.

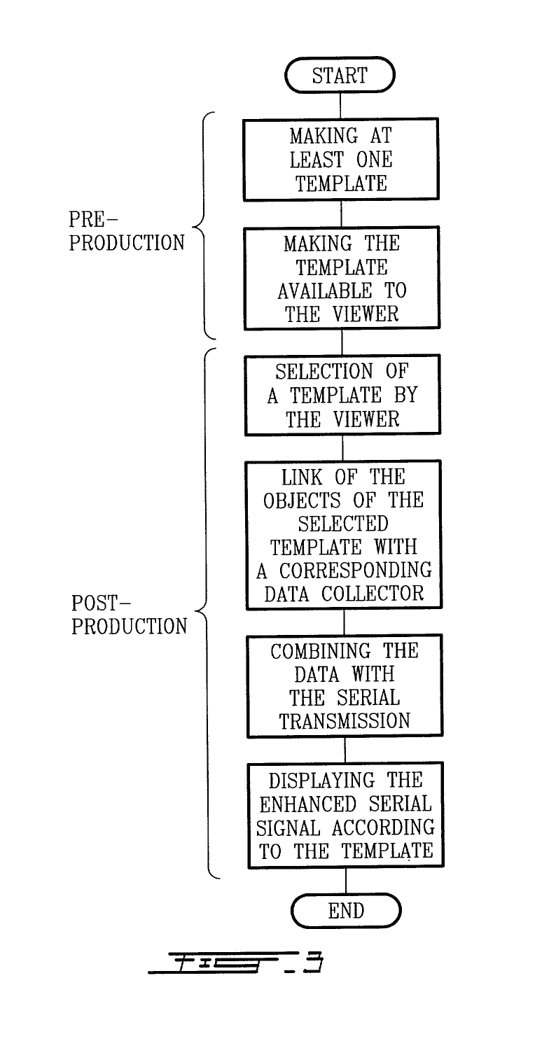

FIG. 3 of the appended drawings illustrates the above described steps of the pre and post production phases.

As will easily be understood by one skilled in the art, the broadcaster 6, the template authoring workstation 24 and the broadcaster website 44 could be contained in the same computer or could be distributed in various locations and interconnected by a computer network such as, for example, the Internet.

Note that although the description of the preferred embodiment makes reference to a viewer's web browser and client plug-ins, it should be understood that a television equipped with an appropriate software and/or hardware capable of selecting and interpreting the templates, or a similarly equipped set-top box, are also contemplated, as are wireless handheld personal communication devices equipped with an appropriate interface.

Although the present invention has been described hereinabove by way of a preferred embodiment thereof, this embodiment can be modified at will, within the scope of the appended claims, without departing from the spirit and nature of the subject invention.

What is claimed is:

1. A system for enhancing a serial transmission with data and presenting it on a display comprising:
means for positioning and displaying the serial transmission on the display;
at least one data collector supplying the data;
at least one viewer selectable graphics object having an appearance, wherein each of said at least one graphics object is connected to a corresponding one of said at least one data collector and wherein each graphics object appearance is modified according to the data of said corresponding one of said at least one data collector; and
means for positioning and presenting said at least one graphics object on the display.

2. A system as recited in claim 1, wherein the serial transmission is presented on the entire display.

3. A system as recited in claim 1, wherein presenting said at least one graphics object comprises superimposing said at least one graphics object on the serial transmission.

4. A system as recited in claim 1, wherein said at least one viewer selectable graphics objet is connected to a corresponding one of said at least one data collector via a marshaller.

5. A system as recited in claim 1, wherein said at least one data collector includes at least one database.

6. A system as recited in claim 1, wherein the serial transmission is a television broadcast.

7. A system as recited in claim 1, wherein the data includes audience responses to an interactive question.

8. A system as recited in claim 1, wherein the data is collected in real time.

9. A system as recited in claim 1, wherein the serial transmission is a television broadcast.

10. A method for a viewer's customization of the presentation of a serial transmission and data on a display comprising:
positioning and displaying the serial transmission on the display;
providing at least one graphics object having respective appearances;
selecting at least one graphics object having an appearance;
positioning said at least one graphics object on the display;
providing at least one data collector having data;
connecting said selected at least one graphics object to a corresponding one of said at least one data collector;
transferring the data from said corresponding data collector to said at least one graphics object; wherein each graphics object appearance is modified according to the data of said corresponding data collector; and
displaying said at least one graphic object on the display.

11. A method as recited in claim 10, wherein displaying the serial transmission comprises displaying the serial transmission on the entire display.

12. A method as recited in claim 10, wherein displaying said at least one graphics object comprises superimposing said at least one graphics object on the serial transmission.

13. A method as recited in claim 10, wherein the serial transmission is a television broadcast.

14. An interactive system for modifying graphics displayed with a serial transmission comprising:
means for requesting viewer input;
means for receiving and processing said viewer input and having an output;
at least one graphics object having an appearance;
means for modifying said appearance of said at least one graphics object connected to said receiving and processing means, wherein said at least one graphics object appearance is modified according to said output;
means for combining said output with the serial transmission to form an enhanced serial transmission.

15. A system as recited in claim 14, wherein said enhanced serial transmission is a television broadcast.

16. A system as recited in claim 14, wherein said combining means superimposing said at least one graphics object on the serial transmission.

17. A method for enhancing a serial transmission and displaying this enhanced transmission on a display comprising the steps of:
in a pre-production phase:
creating a template including at least one graphics object;
making the template available;
in a post production phase:
providing a serial transmission;
providing at least one data collector having data;
acquiring said template;
linking said at least one graphics object of the template to a corresponding data collector;
modifying said at least one graphics object according to the real time modified data of the data collector; and
displaying the combination of said serial transmission and said at least one graphics object on the display.

18. A method as recited in claim 17, wherein said template creating step is done on a personal computer.

19. A method as recited in claim 17, wherein the template is made available via a computer network.

20. A method as recited in claim 17, wherein said displaying step is done through a superimposition of the at least one graphics object on the serial transmission.
